(19) United States
(12) Patent Application Publication
(10) Pub. No.: US 2026/0053114 A1
(43) Pub. Date: Feb. 26, 2026

(54) DYNAMIC COUNTERBALANCE TO PERFORM CHRONIC FREE-BEHAVING RESEARCH WITH SMALL ANIMALS

(71) Applicant: The Regents of the University of California, Oakland, CA (US)

(72) Inventors: Daril EVan Brown, II, West Sacramento, CA (US); Vikash Gilja, San Diego, CA (US); Timothy Q. Gentner, San Diego, CA (US); Derek Hung Nguyen, San Marcos, CA (US); Eugene Duval, Menlo Park, CA (US)

(21) Appl. No.: 19/105,657

(22) PCT Filed: Aug. 25, 2023
(86) PCT No.: PCT/US2023/072935

§ 371 Date: Feb. 21, 2025

Related U.S. Application Data
(60) Provisional application No. 63/373,667, filed on Aug. 26, 2022.

(51) Int. Cl. A01K 15/02; B66D 3/06

(52) U.S. Cl. CPC A01K 15/027; B66D 3/06

(57) ABSTRACT

A dynamic counterbalance system is provided. The dynamic counterbalance system can include a compound pulley system and an adjustment arm. The compound pulley system can include a frame, a spring, a variable radius pulley, a plurality of mounted pulleys, a plurality of moveable pulleys, and a plurality of lines. The adjustment arm can include a mountable support, a spool support, a spool, an arm inner support, a rod support, an extended rod, a rod end cap, a traveling pulley, a dynamic pulley, and a plurality of lines.

### CROSS REFERENCE TO RELATED APPLICATION

This application is a national stage entry of Patent Cooperation Treaty Application No. PCT/US2023/072935 filed Aug. 25, 2023, entitled “DYNAMIC COUNTERBALANCE TO PERFORM CHRONIC FREE-BEHAVING RESEARCH WITH RESEARCH WITH SMALL ANIMALS,” which claims priority to U.S. Provisional Application No. 63/373,667 filed on Aug. 26, 2022, entitled “DYNAMIC COUNTERBALANCE TO PERFORM CHRONIC FREE-BEHAVING RESEARCH WITH RESEARCH WITH SMALL ANIMALS”. The disclosures of which are incorporated herein by reference in their entirety.

### STATEMENT OF GOVERNMENT SUPPORT

This invention was made with government support under DC018446 awarded by the National Institutes of Health. The government has certain rights in the invention.

### TECHNICAL FIELD

The subject matter described herein relates generally to a dynamic counterbalance system, and more specifically a dynamic counterbalance system to enable chronic free-behaving research with small animals.

### BACKGROUND

Both basic science and translational medical research are highly dependent on small animal models. In fact, 95% of all lab animals are mice and rats, according to the Foundation for Biomedical Research (FBR). This is especially true for neurotechnology research. However, working with small animals has several technological hurdles. One of the most difficult engineering hurdles is the small size and low weight tolerance of the small animal models, which not only impedes the rate of scientific progress but also reduces the types of experiments that are possible to conduct in both an experimental and clinical setting. At present, the weight of recording instruments used in small animal research is addressed by using a simple counterweight system. This approach both doubles the inertia on the animal subject, making it harder for them to move, and creates a force that can stress the animal subject. These two effects negatively affect the health of the animal subject and result in the introduction of behavioral confounds into the data being collected, reducing the quality of the data and the results that can be interpreted from them.

Small animal models (e.g. mice, rats, and songbirds) are heavily employed throughout medical research. They are employed to study behaviors and biological phenomena that are difficult to study in humans or larger animal models (e.g. non-human primates, pigs, etc.). Some of the major strengths of small animal models are their size and availability, as well as the accessibility of reliable scientific tools to study them at multiple scales. However, for those who study complex behaviors this small size creates limits on what instruments can be used to record vital data from their subjects. The problem is in part that small animals have a limit to how much additional weight they can bear. Scientists and engineers have attempted to address this problem using three methods: (1) Head fixing the animal, (2) Miniaturizing instruments so that they weigh less, and (3) Counterweighting the recording instruments:
(1) Head Fixing overcomes the weight issue by having recording instruments self-supported and attaching the animal to the recording rig. The animal is held in place and any movement it makes does not cause it to physically move and instead moves a part of the recording setup. Although the animal is freely moving this behavior does not fully encapsulate all of the behavior researchers wish to understand and the animal cannot safely be continuously recorded for days without long resting periods.
(2) Miniaturizing instruments directly addresses the weight problem by reducing the size and weight of the recording instruments. However, there is a fundamental limit to how small and how light recording instruments can be made even with continuous improvements in fabrication techniques.
(3) Counterweighting reduces the stress the subject experiences from the weight of the recording instruments by tying a counterweight of equal or slightly lesser weight. This is often the method of choice for researchers who conduct chronic recordings of free behavior in small animals.

Both miniaturizing instruments and counterweighting are ways for conducting long chronic scientific research with small animal models. However, they both have major weaknesses. Only counterweighting reduces the weight the animal has to bear from the recording instruments, and it does so at the cost of doubling the experienced inertia the animal has to contend with. This means that the animal has to try twice as hard to move with the instrument and the counterweight than if it had to move with the weight of the recording instruments alone. Additionally, counterweights often only balance properly at a single point in the cage, typically the center of the cage, and produce a slight pull towards that equilibrium point at any other point in the cage to which the animal tries to move. The field needs a method that will address the recording instrument weight issue without causing additional stress to the animal.

### SUMMARY

Systems are provided for a dynamic counterbalance.

In an aspect, a dynamic counterbalance system can include a compound pulley system and an adjustment arm. The compound pulley system can include a frame, a spring coupled to the frame, a variable radius pulley, a plurality of mounted pulleys, and a plurality of moveable pulleys. The variable radius pulley can include a first side with a variable radius and a second side with a constant radius, and the spring can be connected to the first side of the variable radius pulley via a first line. The plurality of mounted pulleys can be mounted to the frame. A first and second mounted pulley of the plurality of mounted pulleys can be pivotably mounted to the frame, and a third and fourth mounted pulley of the plurality of mounted pulleys can be fixedly mounted to the frame. The plurality of moveable pulleys can be configured translate relative to the plurality of mounted pulleys. The plurality of moveable pulleys can include a first, second, and third moveable pulley. The first moveable pulley can be connected to the second side of the variable radius pulley via a second line, and the first moveable pulley can be connected to the frame and the first mounted pulley via a first portion of a third line. The second moveable pulley can be connected to the first portion of the third line via a fourth line, and the second moveable pulley can be connected to the first mounted pulley and the second mounted pulley via a second portion of the third line. The third moveable pulley can be connected to the second portion of the third line via a fifth line, and the third moveable pulley can be connected to the second mounted pulley and the third mounted pulley via a third portion of the third line. The third mounted pulley can be connected to the fourth mounted pulley via a fourth portion of the third line. The adjustment arm can include a mountable support, a spool, a rod support, a rod end cap, an extended rod, a traveling pulley, and a dynamic pulley. The mountable support can include an upper support plate and a lower support plate, and the upper support plate can include a spool support. The spool can be rotatably mounted on the spool support, and at least a portion of the spool can be exposed through the upper support plate. The spool can be connected to the fourth mounted pulley via a fifth portion of the third line. A first end of the extended rod can be mounted to the rod support, and the rod end cap can be mounted to the second end of the extended rod. The traveling pulley can be slidably and rotatably mounted on the extended rod. The traveling pulley can be connected to the spool via a first portion of a sixth line, the dynamic pulley can be connected to the traveling pulley via a second portion of the sixth line, and the traveling pulley can be connected to the rod end cap via a third portion of the sixth line.

In some aspects, the dynamic pulley can be configured to be connected to a protective headcap or sensor. The dynamic pulley can include a rotatable protrusion that can be configured to prevent rotation of the dynamic pulley relative to the traveling pulley. The upper support plate and the lower support plate can be configured to clamp a cage or animal housing in order to mount the adjustment arm. The rod support can include a counterbalance rod configured to zero out moments applied to the rod support. The rod support can include a line guide. The rod support can include a first plurality of support anchors, the rod end cap can include a second plurality of support anchors, and the first and second pluralities of support anchors can be connected to each other to support a weight of the extended rod and the rod end cap. The rod support can be configured to rotate 360 degrees around a vertical axis that passes through a center of the spool. A pulley ratio of the dynamic counterbalance system can be 9 to 1. The adjustment arm can include an arm inner support connected to the lower support plate, and the rod support can be mounted onto the arm inner support.

In an aspect, a compound pulley system can include a frame, a spring coupled to the frame, a variable radius pulley, and a plurality of mounted pulleys. The variable radius pulley can include a first side with a variable radius and a second side with a constant radius, and the spring can be connected to the first side of the variable radius pulley via a first line. The plurality of mounted pulleys can be mounted to the frame, a first and second mounted pulley of the plurality of mounted pulleys can be pivotably mounted to the frame, and a third mounted pulley of the plurality of mounted pulleys can be fixedly mounted to the frame. The plurality of moveable pulleys can be configured to translate relative to the plurality of mounted pulleys, and the plurality of moveable pulleys can include a first, second, and third moveable pulley. The first moveable pulley can be connected to the second side of the variable radius pulley via a second line, and the first moveable pulley can be connected to the frame and the first mounted pulley via a first portion of a third line. The second moveable pulley can be connected to the first portion of the third line via a fourth line, and the second moveable pulley can be connected to the first mounted pulley and the second mounted pulley via a second portion of the third line. The third moveable pulley can be connected to the second portion of the third line via a fifth line, and the third moveable pulley can be connected to the second mounted pulley and the third mounted pulley via a third portion of the third line.

In some aspects, the third mounted pulley can be configured to be connected to a protective headcap or sensor via a fourth portion of the third line.

In an aspect, an adjustment arm can include a mountable support, a spool, a rod support, a rod end cap, an extended rod, a traveling pulley, and a dynamic pulley. The mountable support can include an upper support plate and a lower support plate, and the upper support plate can include a spool support. The spool can be rotatably mounted on the spool support, and at least a portion of the spool can be exposed through the upper support plate. A first end of the extended rod can be mounted to the rod support, and the rod end cap can be mounted to a second end of the extended rod. The traveling pulley can be slidably and rotatably mounted on the extended rod. The traveling pulley can be connected to the spool via a first portion of a line, the dynamic pulley can be connected to the traveling pulley via a second portion of the line, and the traveling pulley can be connected to the rod end cap via a third portion of the line.

In some aspects, the spool can be connected to a counterweight or a pulley system. The dynamic pulley can be configured to be connected to a protective headcap or sensor. The dynamic pulley can include a rotatable protrusion that can be configured to prevent rotation of the dynamic pulley relative to the traveling pulley. The rod support can include a counterbalance rod configured to zero out moments applied to the rod support. The rod support can include a first plurality of support anchors, the rod end cap can include a second plurality of support anchors, and the first and second pluralities of support anchors can be connected to each other to support a weight of the extended rod and the rod end cap. The rod support can be configured to rotate 360 degrees around a vertical axis that passes through a center of the spool. The adjustment arm can further include an arm inner support connected to the lower support plate, and the rod support can be mounted onto the arm inner support.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a planar view of a dynamic counterbalance system;

FIG. 2 depicts a side view of a compound pulley system of the dynamic counterbalance system of FIG. 1;

FIG. 3 depicts multiple views of a variable radius pulley of the dynamic counterbalance system of FIG. 1;

FIG. 4 depicts multiple views of a pulley unit of the dynamic counterbalance system of FIG. 1;

FIG. 5 depicts multiple views of a mounted vertical to horizontal pulley block of the dynamic counterbalance system of FIG. 1;

FIG. 6 depicts a top-down view and a side view of an adjustment arm of the dynamic counterbalance system of FIG. 1;

FIG. 7 depicts additional side views of the adjustment arm of FIG. 6;

FIG. 8 depicts multiple views of a mountable support, spool, and spool support of the dynamic counterbalance system of FIG. 1;

FIG. 9 depicts multiple views of a dynamic pulley of the dynamic counterbalance system of FIG. 1;

FIG. 10A and FIG. 10B depict a comparison of off angle forces from a typical counterweight and the dynamic counterbalance system of FIG. 1 acting on a small animal as it moves in a cage;

FIG. 11 depicts multiple views of a lower frame portion of the dynamic counterbalance system of FIG. 1 with the variable radius pulley of FIG. 3 mounted thereupon;

FIG. 12 depicts multiple views of the lower frame portion of FIG. 11 without the variable radius pulley of FIG. 3 mounted thereupon;

FIG. 13 depicts an upper frame portion of the dynamic counterbalance system of FIG. 1 with and without removable pulley mounting portions; and

FIG. 14 depicts multiple view of a lower support plate and inner arm support of the dynamic counterbalance system of FIG. 1.

### DETAILED DESCRIPTION

Utilizing small animal models for long term chronic experiments involves an inherent hurdle of accommodating for their limited weight bearing abilities. Current solutions either require employing simple mechanical solutions (e.g., simple counterweight systems, commutators, and rubber bands) or utilizing cutting edge lightweight wireless technology. A current gold standard counterweight approach creates new problems, namely doubling the effective inertia experienced by the animal test subject and creating off-angle corrective forces that act to move the animal test subject back to the center of their enclosure. Many small animal models are prey animals and can experience significant stress and fear when in the center of their enclosure. These forces and reduced mobility are thought to stress the animal subjects, thus negatively impacting data collection and reducing the time that experiments can be safely conducted. The lightweight technology approach is still not ideal due to both limits in both existing fabrication techniques and current wireless technology. For high throughput recordings, wired recording systems are still better suited for many chronic recording instruments. However, currently most teams only deploy commutators that only address concerns regarding the electrical tether connected to the recording instruments and do not address the weight of the system. There exists a need for a dynamic counterbalance system that can counterbalance the weight of recording instruments without creating off-angle forces that will unnecessarily stress the recording animal subject.

To illustrate how significant the weight issue is for the field, an example experimental setup will be described. In this example experimental set up, recordings use Neural Pixels probes to record neural activity from awake free-behaving zebra finches. Neural Pixels (which are the current state of the art for neural recordings) weigh about 1.8 grams and are impressive in terms of signal count and signal quality for their small size. They are the result of years of improvements in fabrication techniques for miniaturizing electronics. However, a large male zebra finch may weigh at most 16 grams, which means the Neural Pixel alone weighs about 11.25% of the animal test subject's weight. This is the equivalent of attaching about a 20.25 pound (lb.) weight to the top of a 180 lb. man. This estimate doesn't include the weight of the protective headcap that is installed to protect the probe and the bird, the dental cement used to secure the headcap, or the electrical tether that connects the probe to the recording system.

In some embodiments, there is provided a dynamic counterbalance system that may be used to perform chronic free-behaving small animal research. The dynamic counterbalance system reduces the weight of instruments experienced by the instrumented subjects, reduces the inertia of instrumented subjects, and/or reduces the off-angle forces experienced by the instrumented subjects. The dynamic counterbalance system allows for reduced stress on the animal subjects used in research and allows for increased total weight of instruments that can be used safely in these types of research paradigms. The dynamic counterbalance system allows for improved data acquisition of existing experiment paradigms by removing the stress due to instrument weight, increased inertia, and off-angle forces. The dynamic counterbalance system also enables novel experimental protocols that were not previously feasible due to weight constraints. In some embodiments, the dynamic counterbalance system may include a compound pulley system configured to counterbalance the weight of instruments and reduce inertia of instrumented subjects, and an adjustment arm configured to reduce off-angle forces experienced by the instrumented subjects.

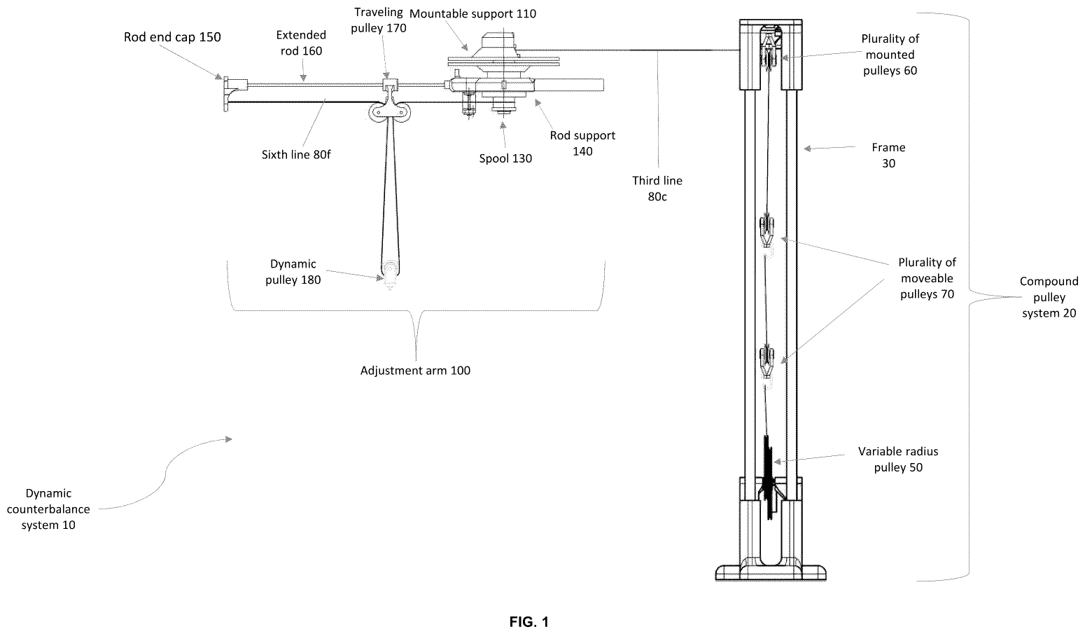

FIG. 1 illustrates a dynamic counterbalance system 10, in accordance with some embodiments. The dynamic counterbalance system 10 can include a compound pulley system 20 (which can be configured to sit next to a cage, for example), an adjustment arm 100 configured to be mounted to for example a cage, and a third line 80c to connect the adjustment arm 100 to the compound pulley system 20 of the dynamic counterbalance system 10. As shown in FIG. 1, the compound pulley system 20 and the adjustment arm 100 can be connected via the third line 80c, which will be described in more detail below.

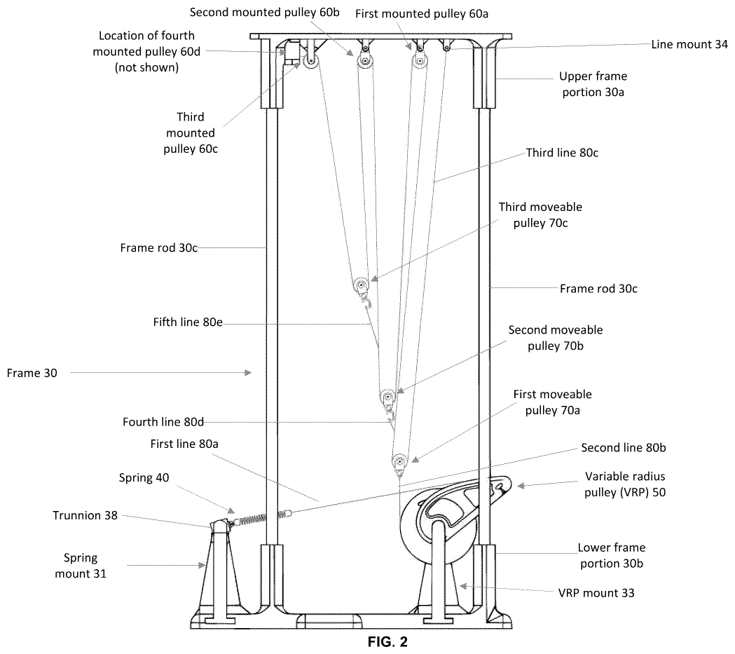

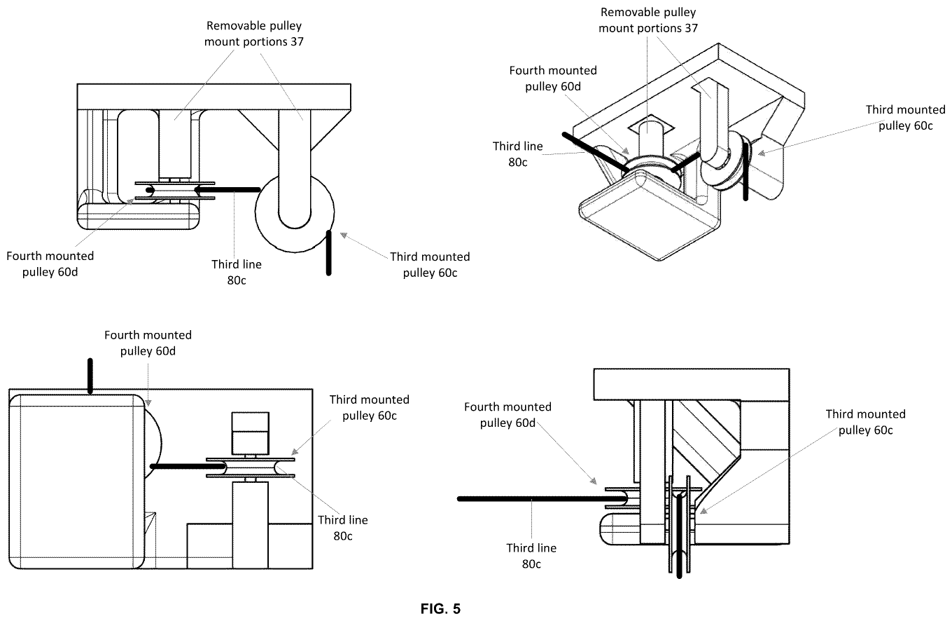

FIG. 2 shows the compound pulley system 20 in more detail. As shown in FIGS. 1 and 2, the compound pulley system 20 can include a frame 30, a spring 40, a variable radius pulley (VRP) 50, a plurality of mounted pulleys 60a-d (mounted pulley 60d shown in FIG. 5), and a plurality of moveable pulleys 70a-c. A plurality of lines 80a-f can be used to connect elements of the dynamic counterbalance system 10.

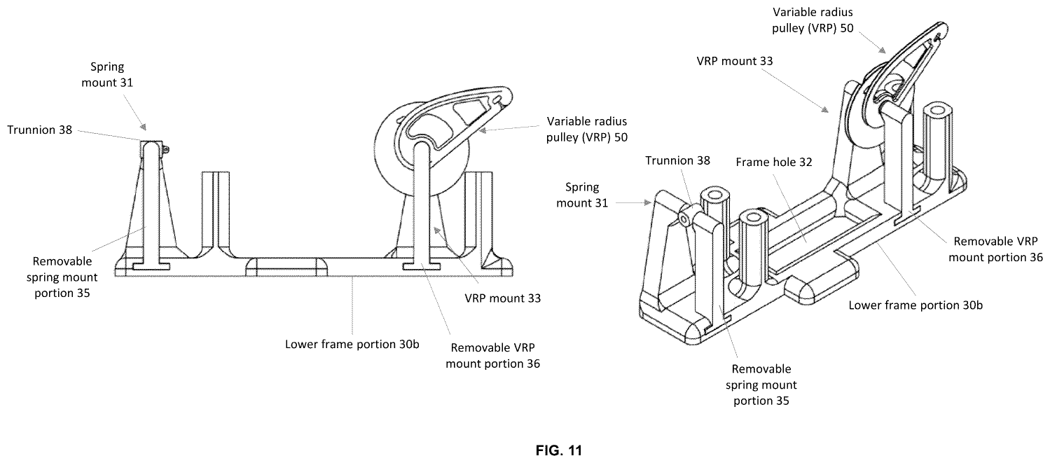

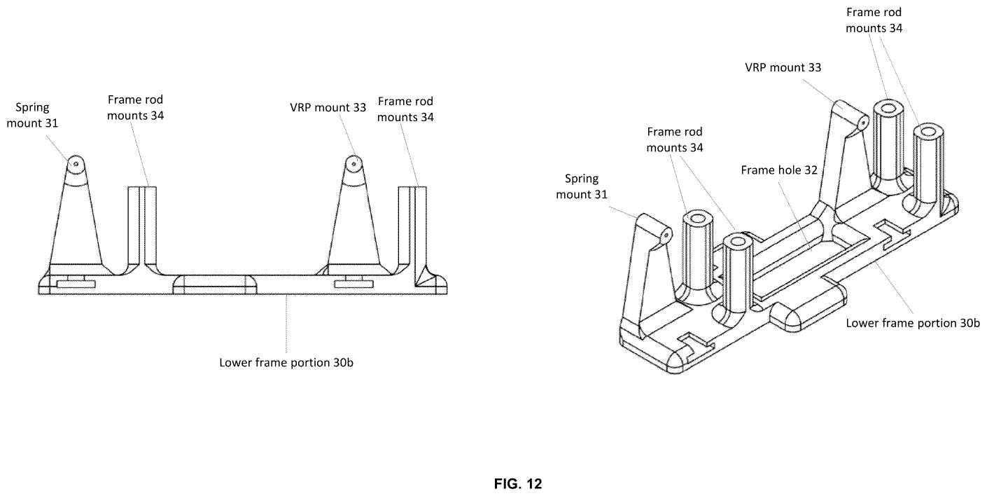

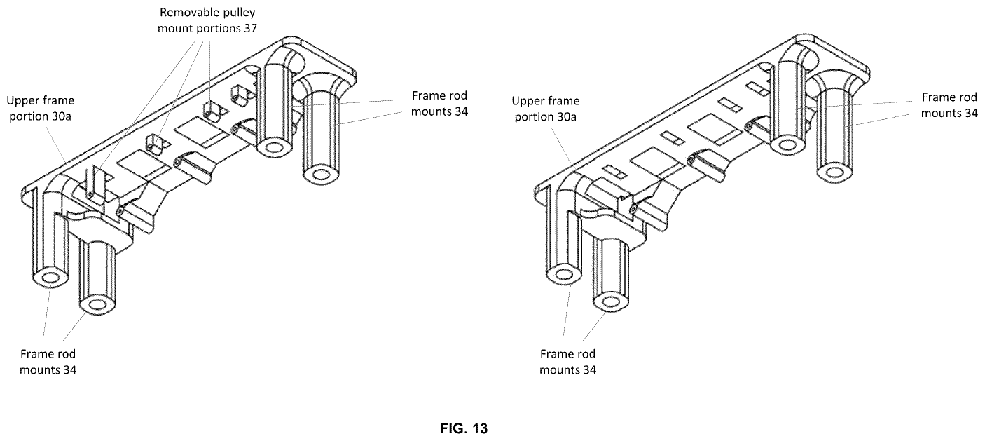

As shown in FIG. 2, the frame 30 can include an upper frame portion 30a, a lower frame portion 30b, and frame rods 30c. The lower frame portion 30b can include a spring mount 31, a trunnion 38, and a VRP mount 33. The upper frame portion 30a can include a line mount 34. The frame 30 may be compact and designed to fit within isolation boxes surrounding an animal enclosure employed in both academia and industry. FIGS. 11 and 12 show the lower frame portion 30b in more detail. The lower frame portion 30b can include a frame hole 32. If the compound pulley system 20 is used without the adjustment arm 100, the compound pulley system 20 can connect to the protective headcap or sensor of an instrumented animal by running a line from the pulleys 60, 70 through the frame hole 32 to the protective headcap or sensor. As shown in FIG. 11, the spring mount 31 can include a trunnion 38 and a removable spring mount portion 35. The spring 40 can directly attach to the trunnion 38, which allows the spring to pivot in response to rotation of the VRP. The removable spring mount portion 35 can slide in or out of the lower frame portion 30b in order to easily mount the spring 40 and easily exchange spring 40 for a different spring depending on the needs of a user, such as requiring more spring force. Similarly, the VRP mount 33 can include a removable VRP mount portion 36 that can slide in or out of the lower frame portion 30b in order to easily mount the VRP 50. This allows the VRP 50 to be easily exchanged for a variety of VRPs in order to adjust the spring force of spring 40 to the appropriate force and torque required. FIG. 12 shows the lower frame portion 30b with the removable spring mount portion 35 and the removable VRP mount portion 36 removed. FIG. 13 shows the upper frame portion 30a in more detail. The upper frame portion 30a can include pulley mounts for mounting mounted pulleys 60a-d. The pulley mounts of upper frame portion 30a can include removable pulley mount portions 37, which are shown in FIGS. 5 and 13. Similarly to the removable spring mount portion 35 and the removable VRP mount portion 36, the removable pulley mount portions 37 can slide in and out of the upper frame portion 30a in order to easily mount mounted pulleys 60a-d. The removable pulley mount portions 37 can allow for easy replacement of the mounted pulleys 60a-d. As shown in FIGS. 11-13, the upper frame portion 30a and the lower frame portion 30b can include frame rod mounts 34 to mount frame rods 30c therebetween and form the frame 30. The length of the frame rods 30c determines the height of the compound pulley system 20 and can be made shorter or taller depending on the needs of the experimental setup. The minimum required length of the frame rods 30c may be determined by the traveling distance required by moveable pulleys 70a-c, which itself is determined by the pulley ratio and pulley conformation of the compound pulley system 20.

As shown in FIG. 2, the plurality of mounted pulleys 60a-d can include a first mounted pulley 60a, a second mounted pulley 60b, a third mounted pulley 60c, and a fourth mounted pulley 60d (shown in FIG. 5). The first mounted pulley 60a and the second mounted pulley 60b can be mounted to the frame 30 in a pivotable manner, such that they can rotate around the mounting point. The third mounted pulley 60c and the fourth mounted pulley 60d can be mounted in a fixed manner such that they cannot pivot about their mounting point and can only spin around their centers. The plurality of moveable pulleys 70a-c can include a first moveable pulley 70a, a second moveable pulley 70b, and a third moveable pulley 70c. The compound pulley system 20 is arranged such that the force applied by the spring 40 is divided as opposed to magnified. This approach allows the dynamic counterbalance system 10 to use commercially available springs, as it is difficult to produce springs with a low spring constant and resulting force profile comparable to the forces produced by a small animal, and it increases the distance the dynamic counterbalance system 10 is able to counterbalance a weight.

As shown in FIG. 2, a first end of the spring 40 can be connected to the spring mount 31 via the trunnion 38 (also shown in FIG. 11), and a second end of the spring 40 can be connected to the VRP 50 via a first line 80a. The VRP 50 can be mounted on the VRP mount 33, which is at the base of the frame 30. The VRP 50 can be connected to the first moveable pulley 70a via a second line 80b. A third line 80c runs between the plurality of mounted pulleys 60a-d and the plurality of moveable pulleys 70a-c. The third line 80c is mounted at a first end to line mount 34, then runs sequentially through the first moveable pulley 70a, the first mounted pulley 60a, the second moveable pulley 70b, the second mounted pulley 60b, the third moveable pulley 70c, the third mounted pulley 60c, and then the fourth mounted pulley 60d to be connected at a second end to the adjustment arm 100. In this manner, the plurality of moveable pulleys 70a-c are suspended by the third line 80c and move up or down with respect to the plurality of mounted pulleys 60a-d in response to a force being applied through the compound pulley system.

As shown in FIG. 2, the second moveable pulley 70b can be connected to the third line 80c via a fourth line 80d. The second moveably pulley 70b may be connected to the fourth line 80d via a miniature carabiner or another suitable connection mechanism. Fourth line 80d can be connected to third line 80c via a prusik knot, a slip knot or another suitable connection. The fourth line 80d can connect the second moveable pulley 70b to the portion of third line 80c that supports the first moveable pulley 70a, increasing the mechanical advantage of the system. Similarly, the third moveable pulley 70c can be connected to the third line 80c via a fifth line 80e. The third moveable pulley 70c may be connected to the fifth line 80e via a miniature carabiner or another suitable connection. The fifth line 80e can connect the third moveable pulley 70c to the portion of third line 80c that supports the second moveable pulley 70b, further increasing the mechanical advantage of the system. The fifth line 80e can be connected to the third line 80c via a prusik knot, a slip knot or another suitable connection. A prusik knot can allow only selective slipping/sliding, which may improve the mechanical advantage of the connections described above. A prusik knot can also allow for easy manual adjustment to the placement of the connections via the fourth line 80d and fifth line 80e, which can help moveable pulleys 70a-c travel easier along third line 80c, improve performance, improve ease of use, and improve adjustability of the dynamic counterbalance system 10 to a user's needs.

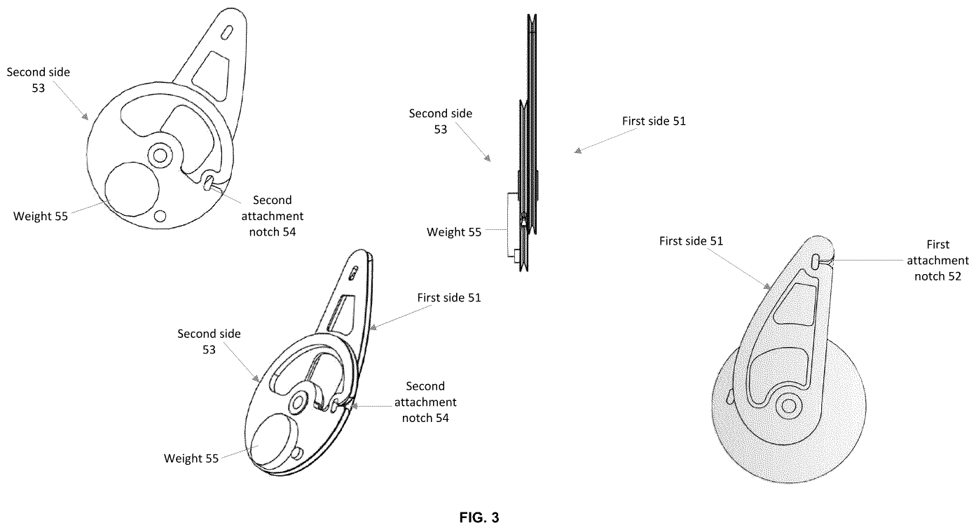

FIG. 3 depicts the variable radius pulley 50 in more detail. The VRP 50 can include first side 51, a first attachment notch 52, a second side 53, a second attachment notch 54, and a weight 55. The VRP 50 can convert the linearly increasing force of the spring 40 into a constant force. This is done by adjusting the radius of curvature of the first side 51 of the VRP 50 to change such that the torque on the second side 53 stays constant as the spring force applied to the first side 51 linearly increases from the spring 40. As more spring force is applied by spring 40, the radius of curvature of the first side 51 decreases such that the torque applied to the first side 51 is a constant value. The second side 53 includes a weight 55. The weight 55 is placed such that the center of mass is aligned with the center of the second side 53. The first attachment notch 52 is located on the first side 51, with a variable radius, and is an attachment point for the first line 80a connecting the spring 40 to the VRP 50. On the second side 53 is the second attachment notch 54, which serves as an attachment point for the second line 80b connecting the VRP 50 to the first moveable pulley 70a. The variable radius pulley 50 can be fine-tuned at the design stage, using code (e.g., python scripts), to counterbalance a specified weight and be used with a spring with a specific spring constant. An initial prototype was designed to counterbalance a weight of 1.8 grams, although other weights may be counterbalanced as well.

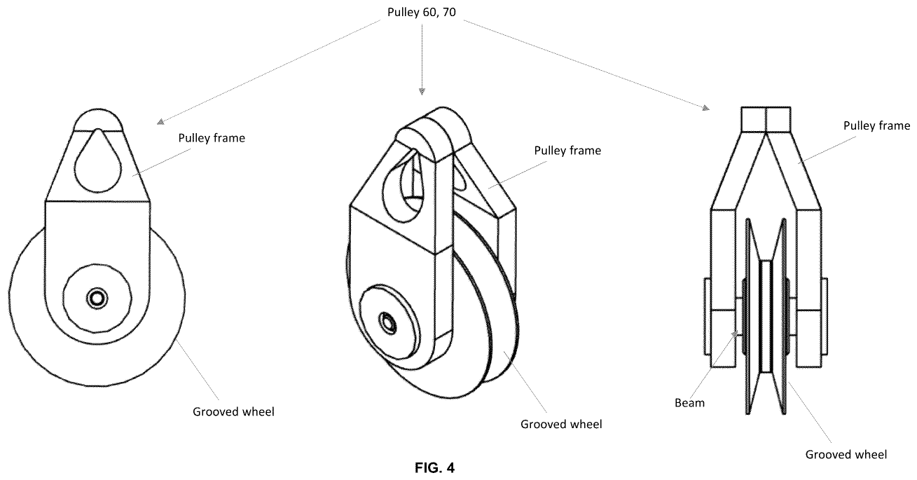

FIG. 4 depicts examples of a pulley unit that can be used as a mounted pulley 60 or a moveable pulley 70. The pulley 60, 70 may include a grooved wheel to direct a line, a pulley frame to hang or mount the pulley, and a beam to mount the grooved wheel. The grooved wheel may be mounted onto the beam with bearings such that the grooved wheel can spin freely around the beam. The pulley frame can include two faces that can be separable or rotatable with respect to each other. This can improve a user's ability to place or replace the grooved wheel and increase the ease with which they do so.

FIG. 5 depicts examples of the third mounted pulley 60c and the fourth mounted pulley 60d in more detail, shown together on a block of the frame 30. As described above, the pulley mounts may include removable pulley mount portions 37, which can allow for easy replacement of the mounted pulleys 60a-d. The fourth mounted pulley 60d can be mounted to the frame 30 in a fixed, non-pivoting manner. The fourth mounted pulley 60d can be oriented horizontally, at a 90°angle relative to the third mounted pulley 60c, in order to guide the third line 80c in a horizontal direction such that it can be connected to the adjustment arm 100. The adjustment arm 100 can be mounted to a center of a cage at a horizontal distance from the compound pulley system 20. When the adjustment arm 100 is mounted to a cage, the adjustment arm 100 can be mounted such that it is at the same vertical height as the fourth mounted pulley 60d.

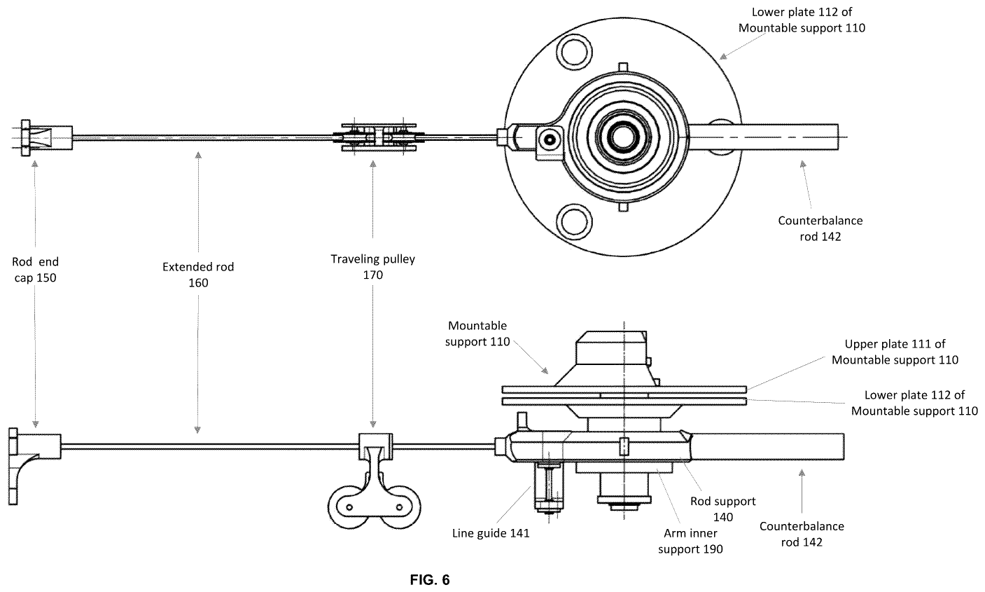

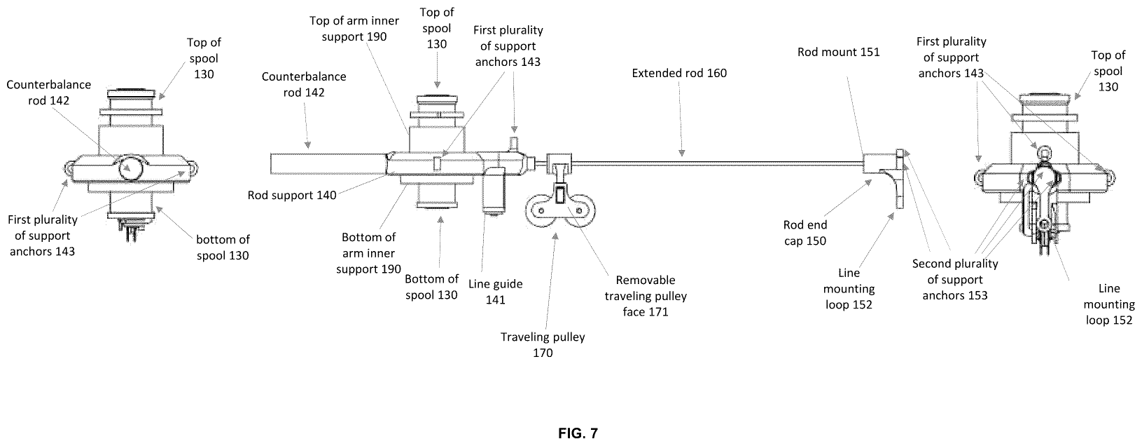

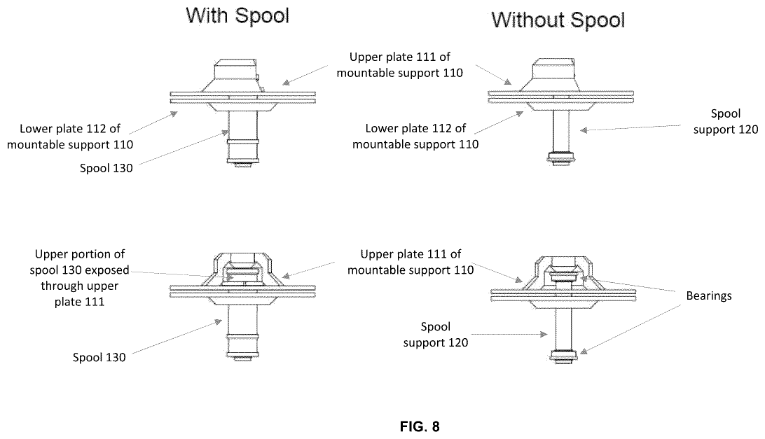

FIGS. 6 and 7 depict the adjustment arm 100 in more detail. The adjustment arm 100 can include a mountable support 110, a spool 130, a rod support 140, a rod end cap 150, an extended rod 160, a traveling pulley 170, a dynamic pulley 180, and a line guide 141. The mountable support 110 can include an upper plate 111 and a lower plate 112. The upper and lower plates 111, 112 of the mountable support 110 can be used to mount the adjustment arm 100 to, for example, a cage housing a small animal. As shown in FIG. 8, upper plate 111 can include a spool support 120. The upper plate 111 can be removed so that the adjustment arm 100, sans the upper plate 111, can be inserted from below a top grate of the cage such that the lower plate 112 pushes up against the bottom of the top grate. Upper plate 111 can then be placed from above the top grate of the cage over the lower plate such that spool support 120 extends through the grate and through lower plate 112. Upper and lower plates 111, 112 can both contain through holes that can then be aligned. A screw or another suitable clamping mechanism can bias the upper and lower plates 111, 112 toward each other, clamping the top grate of the cage between the plates 111, 112.

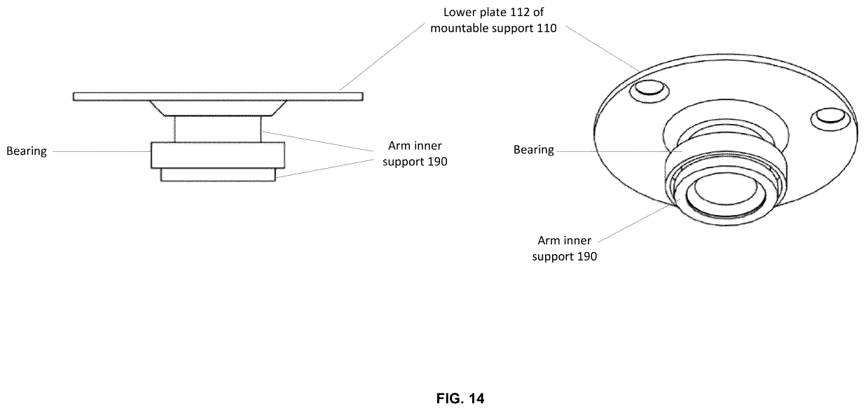

As shown in FIG. 14, an arm inner support 190 can be connected to the lower plate 112. The arm inner support 190 can connect to the lower plate by a friction fit, screw threads, or any other suitable connection mechanism, or may be integrally formed with the lower plate 112. A bearing can be placed onto the arm inner support 190. As shown in FIGS. 6 and 7, the rod support 140 can have a circular portion that can be fit onto the bearing on arm inner support 190. Rod support 140 can spin freely around the inner tube and can rotate 360 degrees. As shown in FIG. 8, the spool 130 can be mounted to the spool support 120 using bearings so that the spool 130 can spin freely around the spool support 120. Spool 130 has a smaller diameter than arm inner support 190 (shown in FIG. 14), and arm inner support 190 can be fit over the spool 130. Spool 130 is separated from the arm inner support 190 with an air gap such that the spool 130 can freely rotate around spool support 120.

As shown in FIGS. 6 and 7, the rod support 140 can include a line guide 141 and a counterbalance rod 142. The rod end cap 150 can include a rod mount 151 and a line mounting loop 152. The extended rod 160 can be mounted at a first end to the rod support 140. The rod end cap 150 can be mounted to the second end of extended rod 160 at the rod mount 151. Rod support 140 can include a first plurality of support anchors 143, and rod end cap 150 can include a second plurality of support anchors 153. Lines can extend between the first and second pluralities of support anchors 143, 153 and be in tension, which helps prevent the extended rod 160 and rod end cap 150 from drooping downward due to their own weight. The first and second pluralities of support anchors 143, 153 may be connected via other suitable connections mechanisms, such as trusses. The counterbalance rod 142 shifts the center of mass to the central axis through the circular portion of rod support 140, thus zeroing out the moments applied to the rod support 140.

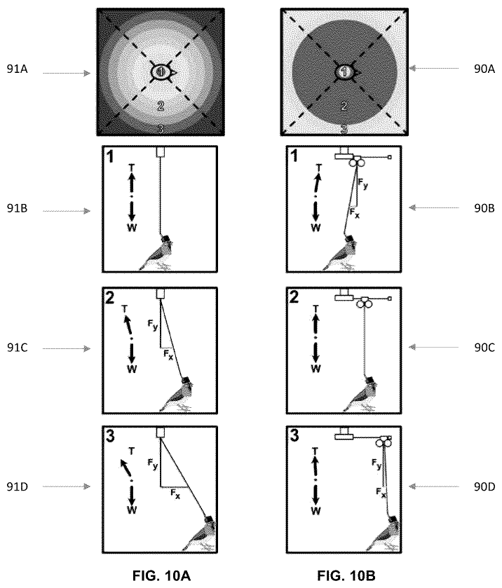

As shown in FIGS. 1, 6, and 7, a traveling pulley 170 can be rotatably and slidably mounted onto extended rod 160 using a bushing, a miniature bearing, or another suitable mechanism within a cylinder radially encompassing the extended rod 160. As shown in FIG. 7, traveling pulley 170 can include a removable traveling pulley face 171, which can be removed in order to place/replace the grooved wheels of the traveling pulley 170, replace bearings within the traveling pulley 170, and other adjustments to the traveling pulley 170. Traveling pulley 170 can slide axially along the extended rod 160 such that traveling pulley 170 is approximately directly above an instrumented small animal as it moves around in the cage. Traveling pulley 170 can also rotate about the extended rod 160 to reduce off-angle forces as the animal moves out to the side of the extended rod 160. When the animal moves out to the side of the extended rod 160, traveling pulley 170 is no longer directly above the animal. Traveling pulley 170 rotates about the extended rod 160 to face the small animal, and rod support 140 then rotates such that extended rod 160 and traveling pulley 170 are once again approximately directly above the animal. This function of the adjustment arm 100 allows the animal to experience very little inertia and off-angle forces for a large portion of the cage compared to other counterbalances, as illustrated in FIGS. 10A-B. Typically when using a counterweight system the equilibrium point is the center of the animal enclosure, however for most small prey animals the center of the enclosure is the least desirable location for them. The adjustment arm 100 allows most of the enclosure to have the system balanced and only the center or the extreme corners of the enclosure will have a slight off angle imbalance.

FIG. 10B shows the adjustment arm 100 in use with an instrumented animal in an enclosure. 90A is a top view into the animal enclosure, with example positions of the animal labeled “1”, “2”, and “3”. As illustrated with shading in 90A, an instrumented animal in the direct center of the enclosure (where it cannot be directly under the extended rod 160) experiences a mild off-angle force, an instrumented animal in the majority of the enclosure and away from the direct center of the enclosure (where it can be directly under the extended rod 160) does not experience any off-angle forces, and an instrumented animal at the edges and corners of the enclosure (where it cannot be directly under the extended rod 160) experiences a mild off-angle force. This is further illustrated in 90B-90D, where W (weight) shows the force vector applied to the animal by the weight of the instrument, and T (tension) shows the force vector applied to the animal by the dynamic counterbalancing system 10. 90B shows that an instrumented animal in position 1, the direct center of the enclosure, experiences a small off-angle force Fx due to the directions of the T and W forces, urging the animal radially outward. 90C shows that an instrumented animal in position 2, the majority of the enclosure and away from the direct center of the enclosure, does not experience an off-angle force as the T and W forces completely counteract each other. 90D shows that an instrumented animal in position 3, the edge of the enclosure, experiences a small off-angle force due to the directions of the T and W forces, urging the animal radially inward.

FIG. 10A shows a counterweight system without an adjustment arm 100 in use with an instrumented animal in an enclosure. As with FIGS. 10B, 91A is a top view into the animal enclosure, with example positions of the animal labeled “1”, “2”, and “3”. As illustrated with shading in 91A, an instrumented animal in the direct center of the enclosure (where it is directly under the counterweight system) does not experience any off-angle forces, an instrumented animal in the majority of the enclosure and away from the direct center of the enclosure experiences moderate off-angle forces, and an instrumented animal at the edges and corners of the enclosure experiences severe off-angle forces. As the instrumented animal moves radially outward, the distance between the instrumented animal and the counterweight system increases, thus increasing the off-angle forces. This is further illustrated in 91B-91D, where W (weight) shows the force vector applied to the animal by the weight of the instrument, and T (tension) shows the force vector applied to the animal by the counterweight system. 91B shows that an instrumented animal in position 1, the direct center of the enclosure, does not experience an off-angle force as the T and W forces completely counteract each other. 91C shows that an instrumented animal in position 2, the majority of the enclosure and away from the direct center of the enclosure, experiences a moderate off-angle force due to the directions of the T and W forces, urging the animal radially inward. 91D shows that an instrumented animal in position 3, the edge of the enclosure, experiences a severe off-angle force due to the directions of the T and W forces, strongly urging the animal radially inward. These off-angle forces can have a significant effect on the behavior of an instrumented animal and can introduce confounds.

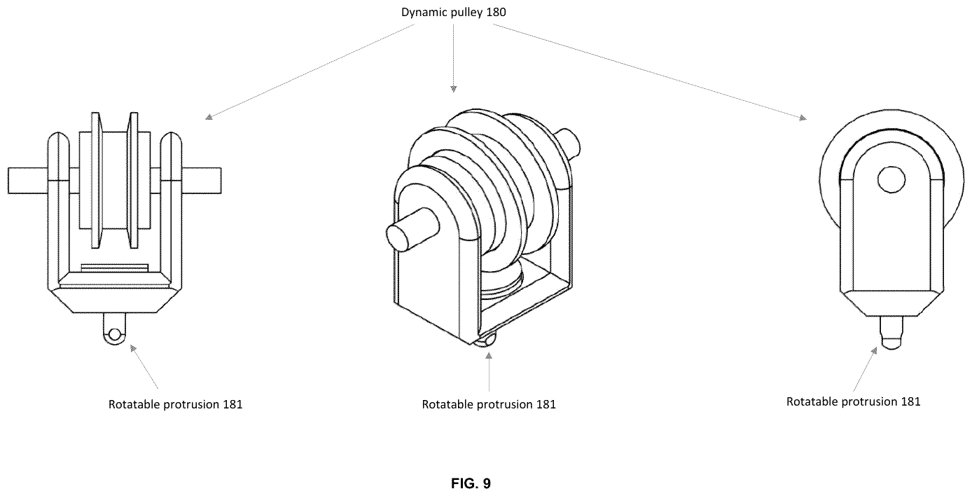

The adjustment arm 100 can further include the dynamic pulley 180, which is shown in FIGS. 1 and 9. This dynamic pulley 180 can be 3D printed and can weigh under one gram. The dynamic pulley 180 includes a rotatable protrusion 181 that is connected by a line to the instruments the animal wears, such as a protective headcap or a sensor. The rotatable protrusion 181 freely rotates within the housing of the dynamic pulley 180 via a bearing, bushing, or other suitable mechanism so that the animal spinning or turning does not twist the sixth line 80f between the dynamic pulley 180 and the traveling pulley 170. Twisting the line can interfere with the tension in the line and can cause the counterbalances forces to not properly transfer to the dynamic pulley 180 and/or can prevent the traveling pulley 170 from traveling along the extended rod 160. As shown in FIG. 6, the mountable support 110 includes a through hole running through its center, which allows any commercially available electrical tether to pass through it. This means that the system is compatible with all active and passive commutator systems available on the market. Electrical wires can be routed from the instrumented animal to this through hole and connect to a commutator. For highly mobile small animals such as songbirds it is necessary to prevent the tethers—the electrical wire which connects to the recording system and the mechanical sixth line 80f which connects to the spool 130—from wrapping around each other in a way that limits the animal's mobility. Having two tethers that move independently of each other means that there is no way the tethers will not wrap around each other. The tethers wrapping around each other can have negative effects similar to those described above for twisting of the sixth line 80f. The dynamic pulley 180, spool 130, and the through hole of mountable support 110 allow the two tethers to wrap each other without compromising either tether's functionality or limiting the mobility of the animal subject.

The dynamic pulley 180 can be a pulley with a 2-to-1 pulley ratio, and can be arranged in reverse of the mounted pulleys 60 and moveable pulleys 70 of the compound pulley system 20 such that the overall pulley ratio of the dynamic counterbalancing system can be 9-to-1. Other pulley ratios can also be used depending on various factors, e.g. the force output of the spring, the strength of the test animal, and other factors.

As shown in FIG. 8, the upper plate 111 can partially cover spool 130, leaving a portion of spool 130 exposed. The third line 80c, attached at a first end to line mount 34 of frame 30, running through the pulleys 60a-d, 70a-c of compound pulley system 20, and exiting through fourth mounted pulley 60d, can be attached at a second end to the upper portion of spool 130, as shown in FIG. 1. The third line 80c can be attached to the spool 130 via an attachment notch, glue, or another suitable mechanism. This can be the only connection between the compound pulley system 20 and the adjustment arm 100, and can connect them over a long distance. The upper portion of the spool 130 can be at the same vertical height as the fourth mounted pulley 60d in order for the third line 80c to stay horizontal as it runs between the compound pulley system 20 and the adjustment arm 100. As shown in FIG. 1, a sixth line 80f can be connected at one end to the lower portion of spool 130, form a loop through traveling pulley 170 to support dynamic pulley 180, and be mounted at a second end to the line mounting loop 152 of rod end cap 150. The sixth line 80f can be attached to the spool 130 and the rod end cap 150 via attachment notches, glue, or another suitable mechanism. Line guide 141 of rod support 140 can help guide the sixth line 80f from the bottom portion of spool 130 toward the center axis of rod 160.

Many elements of the dynamic counterbalancing system 10 are capable of being 3D printed (or manufactured in other ways) and may be significantly cheaper to make than existing technologies often deployed in science and industry research. For example, the upper and lower frame portions 30a-b, VRP 50, mountable support 110, rod support 140, spool support 120, spool 130, inner arm support 190, rod end cap 150, and dynamic pulley 180 can be 3D printed.

The dynamic counterbalancing system 10 described above provides a low cost system that addresses several of the pressing weight constraints of chronic small animal experiments. The dynamic counterbalancing system 10 can enable researchers to conduct experiments that would not have been possible due to weight restrictions of existing recording instruments. The compound pulley system 20 can also be mounted above the cage and used without the adjustment arm 100. When the compound pulley system 20 is used without the adjustment arm and is instead mounted above the cage, the vertical to horizontal conversion functionality of the fourth mounted pulley 60d is not necessary, and thus the fourth mounted pulley 60d can be removed from the compound pulley system 20 or the third line 80c may not be ran through the fourth mounted pulley 60d. In addition, the adjustment arm 100 can also work without the compound pulley system 20 and instead be used with a traditional counterweight or a weight hung by a simple or complex pulley system.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A dynamic counterbalance system, comprising:
a compound pulley system, wherein the compound pulley system comprises:
a frame,
a spring coupled to the frame,
a variable radius pulley comprising a first side with a variable radius and a second side with a constant radius, wherein the spring is connected to the first side of the variable radius pulley via a first line,
a plurality of mounted pulleys, wherein the plurality of mounted pulleys are mounted to the frame, wherein a first and second mounted pulley of the plurality of mounted pulleys are pivotably mounted to the frame, and wherein a third and fourth mounted pulley of the plurality of mounted pulleys are fixedly mounted to the frame,
a plurality of moveable pulleys, wherein the plurality of moveable pulleys are configured to translate relative to the plurality of mounted pulleys, wherein the plurality of moveable pulleys comprises a first, second, and third moveable pulley,
wherein the first moveable pulley is connected to the second side of the variable radius pulley via a second line, and the first moveable pulley is connected to the frame and the first mounted pulley via a first portion of a third line,
wherein the second moveable pulley is connected to the first portion of the third line via a fourth line, and the second moveable pulley is connected to the first mounted pulley and the second mounted pulley via a second portion of the third line, and
wherein the third moveable pulley is connected to the second portion of the third line via a fifth line, and the third moveable pulley is connected to the second mounted pulley and the third mounted pulley via a third portion of the third line, and
wherein the third mounted pulley is connected to the fourth mounted pulley via a fourth portion of the third line; and
an adjustment arm, wherein the adjustment arm comprises:
a mountable support comprising an upper support plate and a lower support plate,
wherein the upper support plate comprises a spool support,
a spool, wherein the spool is rotatably mounted on the spool support, wherein at least a portion of the spool is exposed through the upper support plate, wherein the spool is connected to the fourth mounted pulley via a fifth portion of the third line,
a rod support,
a rod end cap,
an extended rod, wherein a first end of the extended rod is mounted to the rod support, and the rod end cap is mounted to a second end of the extended rod,
a traveling pulley, wherein the traveling pulley is slidably and rotatably mounted on the extended rod, and
a dynamic pulley,
wherein the traveling pulley is connected to the spool via a first portion of a sixth line, the dynamic pulley is connected to the traveling pulley via a second portion of the sixth line, and the traveling pulley is connected to the rod end cap via a third portion of the sixth line.

2. The dynamic counterbalance system of claim 1, wherein the dynamic pulley is configured to be connected to a protective headcap or sensor.

3. The dynamic counterbalance system of claim 1, wherein the dynamic pulley comprises a rotatable protrusion that is configured to prevent rotation of the dynamic pulley relative to the traveling pulley.

4. The dynamic counterbalance system of claim 1, wherein the upper support plate and the lower support plate are configured to clamp a cage or animal housing in order to mount the adjustment arm.

5. The dynamic counterbalance system of claim 1, wherein the rod support comprises a counterbalance rod configured to zero out moments applied to the rod support.

6. The dynamic counterbalance system of claim 1, wherein the rod support comprises a line guide.

7. The dynamic counterbalance system of claim 1, wherein the rod support comprises a first plurality of support anchors, the rod end cap comprises a second plurality of support anchors, and the first and second pluralities of support anchors are connected to each other to support a weight of the extended rod and the rod end cap.

8. The dynamic counterbalance system of claim 1, wherein the rod support is configured to rotate 360 degrees around a vertical axis that passes through a center of the spool.

9. The dynamic counterbalance system of claim 1, wherein a pulley ratio of the dynamic counterbalance system is 9 to 1.

10. The dynamic counterbalance system of claim 1, wherein the adjustment arm further comprises an arm inner support connected to the lower support plate, and wherein the rod support is mounted onto the arm inner support.

11. A compound pulley system, wherein the compound pulley system comprises:
a frame,
a spring coupled to the frame,
a variable radius pulley comprising a first side with a variable radius and a second side with a constant radius, wherein the spring is connected to the first side of the variable radius pulley via a first line,
a plurality of mounted pulleys, wherein the plurality of mounted pulleys are mounted to the frame, wherein a first and second mounted pulley of the plurality of mounted pulleys are pivotably mounted to the frame, and wherein a third mounted pulley of the plurality of mounted pulleys is fixedly mounted to the frame,
a plurality of moveable pulleys, wherein the plurality of moveable pulleys are configured to translate relative to the plurality of mounted pulleys, wherein the plurality of moveable pulleys comprises a first, second, and third moveable pulley,
wherein the first moveable pulley is connected to the second side of the variable radius pulley via a second line, and the first moveable pulley is connected to the frame and the first mounted pulley via a first portion of a third line,
wherein the second moveable pulley is connected to the first portion of the third line via a fourth line, and the second moveable pulley is connected to the first mounted pulley and the second mounted pulley via a second portion of the third line, and
wherein the third moveable pulley is connected to the second portion of the third line via a fifth line, and the third moveable pulley is connected to the second mounted pulley and the third mounted pulley via a third portion of the third line.

12. The compound pulley system of claim 11, wherein the third mounted pulley is configured to be connected to a protective headcap or sensor via a fourth portion of the third line.

13. An adjustment arm, wherein the adjustment arm comprises:
a mountable support comprising an upper support plate and a lower support plate,
wherein the upper support plate comprises a spool support,
a spool, wherein the spool is rotatably mounted on the spool support, wherein at least a portion of the spool is exposed through the upper support plate,
a rod support,
a rod end cap,
an extended rod, wherein a first end of the extended rod is mounted to the rod support, and the rod end cap is mounted to a second end of the extended rod,
a traveling pulley, wherein the traveling pulley is slidably and rotatably mounted on the extended rod, and
a dynamic pulley,
wherein the traveling pulley is connected to the spool via a first portion of a line, the dynamic pulley is connected to the traveling pulley via a second portion of the line, and the traveling pulley is connected to the rod end cap via a third portion of the line.

14. The adjustment arm of claim 13, wherein the spool is connected to a counterweight or a pulley system.

15. The adjustment arm of claim 13, wherein the dynamic pulley is configured to be connected to a protective headcap or sensor.

16. The adjustment arm of claim 13, wherein the dynamic pulley comprises a rotatable protrusion that is configured to prevent rotation of the dynamic pulley relative to the traveling pulley.

17. The adjustment arm of claim 13, wherein the rod support comprises a counterbalance rod configured to zero out moments applied to the rod support.

18. The adjustment arm of claim 13, wherein the rod support comprises a first plurality of support anchors, the rod end cap comprises a second plurality of support anchors, and the first and second pluralities of support anchors are connected to each other to support a weight of the extended rod and the rod end cap.

19. The adjustment arm of claim 13, wherein the rod support is configured to rotate 360 degrees around a vertical axis that passes through a center of the spool.

20. The adjustment arm of claim 13, wherein the adjustment arm further comprises an arm inner support connected to the lower support plate, and wherein the rod support is mounted onto the arm inner support.
